(19) United States
(12) Patent Application Publication
(10) Pub. No.: US 2026/0202563 A1
(43) Pub. Date: Jul. 16, 2026

(54) HIGH-FREQUENCY, POWERFUL, REPEATABLE IMPACT SEISMIC SOURCE SYSTEM AND IMPACT METHOD

(71) Applicant: CCTEG COAL MINING RESEARCH INSTITUTE, BEIJING (CN)

(72) Inventors: FUQIANG GAO, BEIJING (CN); CHUNYANG CUI, BEIJING (CN); WENJU LIU, BEIJING (CN); JINHONG YANG, BEIJING (CN); XIAOQING WANG, BEIJING (CN); GUIYANG YUAN, BEIJING (CN); LIQUN ZHONG, BEIJING (CN); JIONG WEI, BEIJING (CN)

(21) Appl. No.: 19/310,945

(22) Filed: Aug. 27, 2025

(30) Foreign Application Priority Data
Jan. 14, 2025 (CN) 202510053180.8

(51) Int. Cl. G01V 1/104

(52) U.S. Cl. CPC G01V 1/104

(57) ABSTRACT

A high-frequency, powerful, repeatable impact seismic source system includes: a barrel, provided with a firing chamber, a recovery chamber and an impact chamber connected sequentially; an impact projectile, sealingly and slidably provided within the impact chamber along an axial direction of the barrel; a firing apparatus, an air outlet end of the firing apparatus being coupled to an air inlet end of the firing chamber, the firing apparatus charges the firing chamber with gas to a predetermined pressure, and the impact projectile moves in a direction away from the recovery chamber driven by the gas; and a recovery apparatus, an air inlet end of the recovery apparatus being coupled to the air outlet end of the recovery chamber, the recovery apparatus evacuates the recovery chamber to a predetermined vacuum degree to enable the impact projectile to move in a direction close to the recovery chamber.

### CROSS-REFERENCE TO RELATED PATENT APPLICATION

This application is based on and claims priority to Chinese patent application No. 202510053180.8, filed on Jan. 14, 2025, the entire contents of which are hereby introduced into this application as a reference.

### FIELD OF THE DISCLOSURE

The present disclosure relates to a field of impact seismic source technologies, and more particularly to a high-frequency, powerful, repeatable impact seismic source system and an impact method.

### BACKGROUND OF THE DISCLOSURE

Before designing and constructing underground projects, it is necessary to explore a detailed geological structure of an operation region as finely as possible in order to achieve reasonable economic design, early warning and prevention of underground engineering geological disasters. Important non-contact geophysical exploration technologies mainly include an electromagnetic method and a seismic exploration method, both of which have their own strengths. The electromagnetic method is sensitive to a region with abnormal resistivity, having mature development in fields of a water-bearing structure in an advanced zone and low-resistance hydrological detection, while the seismic exploration method is sensitive to a region with abnormal seismic wave impedance, such as a coal-rock interface, a fault zone, a collapse column, an unconformity structure, and other regions prone to seismic wave scattering. Therefore, if it is intended to explore distribution of geological structures in an underground space, the seismic exploration method is a first choice.

### SUMMARY OF THE DISCLOSURE

A first aspect of the present disclosure provides a high-frequency, powerful, repeatable impact seismic source system. The system includes: a barrel, provided with a firing chamber, a recovery chamber and an impact chamber connected sequentially; an impact projectile, sealingly and slidably provided within the impact chamber along an axial direction of the barrel; a firing apparatus, an air outlet end of the firing apparatus being coupled to an air inlet end of the firing chamber, the firing apparatus being configured to charge the firing chamber with gas to a predetermined pressure, in which, the impact projectile is configured to move in a direction away from the recovery chamber driven by the gas with a pressure reaching the predetermined pressure; and a recovery apparatus, an air inlet end of the recovery apparatus being coupled to the air outlet end of the recovery chamber, the recovery apparatus being configured to evacuate the recovery chamber to a predetermined vacuum degree to enable the impact projectile to move in a direction close to the recovery chamber.

A second aspect of the present disclosure provides an impact method, for the high-frequency, powerful, repeatable impact seismic source system as described in the first aspect of the present disclosure. The method includes: S1, determining design parameters of the system according to a predetermined single firing energy, and preparing the system according to the design parameters, in which, the design parameters include: a predetermined pressure of a gas driving an impact projectile in the system, a cross-sectional area of the impact projectile, a volume of a firing chamber in the system, and a length of the impact projectile; S2, charging the firing chamber with gas to the predetermined pressure using the firing apparatus in the system; S3, releasing the gas with a pressure reaching the predetermined pressure in the firing chamber to drive the impact projectile to move in a direction away from a recovery chamber in the system; S4, evacuating the recovery chamber to a predetermined vacuum degree using a recovery apparatus in the system, to enable the impact projectile to move in a direction close to the recovery chamber; S5, repeating steps S2 to S4 at a predetermined frequency.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic structural diagram of high-frequency, powerful, repeatable impact seismic source system according to an embodiment of the present disclosure (at a firing preparation phase).

FIG. 2 is a schematic structural diagram of high-frequency, powerful, repeatable impact seismic source system according to an embodiment of the present disclosure (at a firing phase).

FIG. 3 is a schematic structural diagram of high-frequency, powerful, repeatable impact seismic source system according to an embodiment of the present disclosure (at a recovery phase).

FIG. 4 is a flow chart of an impact method according to an embodiment of the present disclosure.

As illustrated in figures: 1: Barrel; 11: Firing chamber; 12: Recovery chamber; 13: Impact chamber; 2: Impact projectile; 3: Firing apparatus; 31: High-pressure air source; 32: Third valve; 33: First air pressure gauge; 34: Pressure regulating valve; 4: Recovery apparatus; 41: Vacuum pump; 42: Second air pressure gauge; 5: a first valve bod; 6: a second valve; 7: a first limiter; 8: uniformly loaded plate; 9: a sliding bar; 10: a second limiter.

### DETAILED DESCRIPTION OF THE EXEMPLARY EMBODIMENTS

Reference will be made in detail to embodiments of the present disclosure. Examples of the embodiments of the present disclosure will be shown in drawings, in which the same or similar elements and the elements having same or similar functions are denoted by like reference numerals throughout the descriptions. The embodiments described herein with reference to drawings are explanatory, illustrative, and used to generally understand the present disclosure. The embodiments shall not be construed to limit the present disclosure. Instead, the embodiments of the present disclosure include all the variants, modifications and their equivalents within the spirit and scope of the present disclosure as defined by the claims.

Before designing and constructing underground projects, it is necessary to explore a detailed geological structure of an operation region as finely as possible in order to achieve reasonable economic design, early warning and prevention of underground engineering geological disasters. Important non-contact geophysical exploration technologies mainly include an electromagnetic method and a seismic exploration method, both of which have their own strengths. The electromagnetic method is sensitive to a region with abnormal resistivity, having mature development in fields of a water-bearing structure in an advanced zone and low-resistance hydrological detection, while the seismic exploration method is sensitive to a region with abnormal seismic wave impedance, such as a coal-rock interface, a fault zone, a collapse column, an unconformity structure, and other regions prone to seismic wave scattering. Therefore, if it is intended to explore distribution of geological structures in an underground space, the seismic exploration method is a first choice.

Presently, hammering-type seismic source equipment is widely used in shallow and deep seismic exploration, but generally because of its low energy, an energy of artificially fired seismic waves is primarily composed of shallow surface waves, thus, the hammering-type seismic source equipment is generally used for shallow seismic exploration imaging. This type of equipment has an important technical bottleneck, that a weight of a hammer is light (generally 5 kg-50 kg). Only the lightweight hammer may perform firing and recovery cycle operations more conveniently, such as a handheld hammer. A portable hydraulic lifting hammer is a portable seismic source that slowly lifts the hammer along a ground support rod through a hydraulic chamber inside the hammer, and then suddenly releases pressure to drop and strike relying on gravity.

In order to solve problems of small hammering energy and inability to perform deep body wave exploration due to the lightweight hammer, some solutions use a super massive hammer (100 kg-15000 kg), but disadvantages of this method are very obvious, that is, it is difficult to effectively accelerate the super massive hammer with common machinery. In addition, after the super massive hammer falls to the ground, it becomes difficult to lift the super massive hammer back to a firing position, which limits the current application of the super massive hammer in deep seismic exploration currently, because the seismic exploration requires the seismic source to be repeatedly fired on the ground a plurality of times and at a plurality of points, and too large a mass of the hammer may make it difficult to lift, cyclic firing, and mobile firing.

Therefore, how to achieve high-speed, powerful launch and rapid and smooth recovery of a large-mass impact projectile is an urgent problem to be solved.

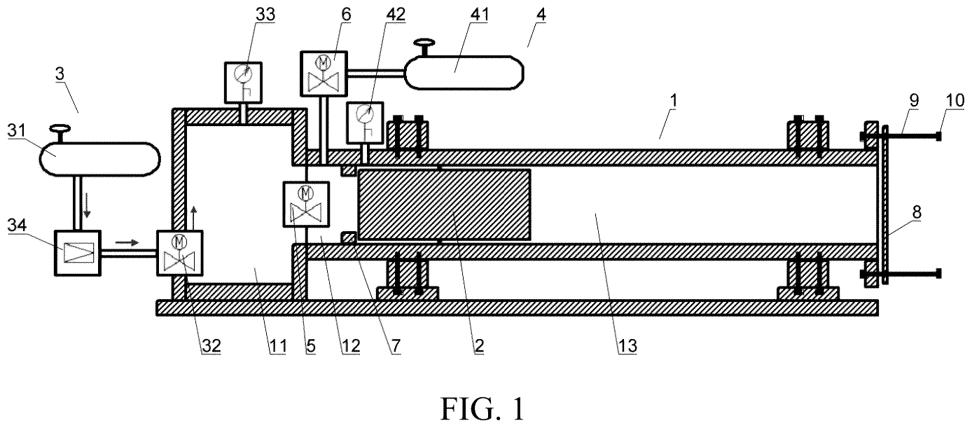

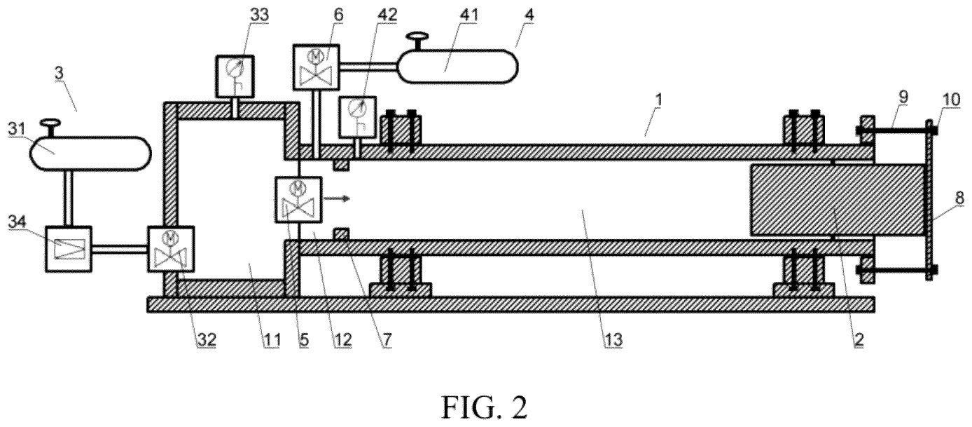

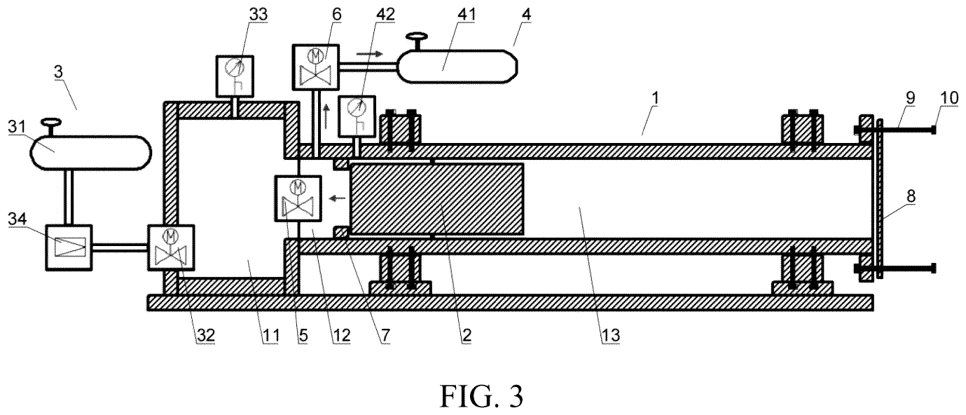

As illustrated in FIG. 1, FIG. 2, and FIG. 3, embodiments of the present disclosure provide a high-frequency, powerful, repeatable impact seismic source system. The system includes: a barrel 1, an impact projectile 2, a firing apparatus 3 and a recovery apparatus 4. The barrel 1 is provided with a firing chamber 11, a recovery chamber 12 and an impact chamber 13 connected sequentially. The impact projectile 2 is sealingly and slidably provided within the impact chamber 13 along an axial direction of the barrel 1. An air outlet end of the firing apparatus 3 is coupled to an air inlet end of the firing chamber 11, the firing apparatus 3 is configured to charge the firing chamber 11 with gas to a predetermined pressure, and the impact projectile 2 is configured to move in a direction away from the recovery chamber 12 driven by the gas with a pressure reaching the predetermined pressure. An air inlet end of the recovery apparatus 4 is coupled to the air outlet end of the recovery chamber 12, and the recovery apparatus 4 is configured to evacuate the recovery chamber 12 to a predetermined vacuum degree to enable the impact projectile 2 to move in a direction close to the recovery chamber 12.

It can be understood that since the impact projectile 2 is sealingly and slidably provided within the impact chamber 13 along an axial direction of the barrel 1, and the air outlet end of the firing apparatus 3 is coupled to the air inlet end of the firing chamber 11, the firing apparatus 3 can charge the firing chamber 11 with gas to the predetermined pressure, and the impact projectile 2 can move in the direction away from the recovery chamber 12 driven by the gas with a pressure reaching the predetermined pressure. Since the air inlet end of the recovery apparatus 4 is coupled to the air outlet end of the recovery chamber 12, the recovery apparatus 4 can evacuate the recovery chamber 12 to the predetermined vacuum degree, such that the impact projectile 2 moves in the direction close to the recovery chamber 12.

The gas with the pressure reaching the predetermined pressure achieved by the firing apparatus 3 enables high-speed and powerful launch of the impact projectile 2, and the predetermined vacuum degree achieved by the recovery apparatus 4 enables rapid and smooth recovery of the impact projectile 2. Therefore, the system, as a seismic source, can perform high-frequency, powerful and repeatable impacts, thereby meeting requirements of shallow and deep seismic exploration.

It should be noted that the barrel 1 is used to form the impact chamber 13 for arranging and guiding the impact projectile 2, the firing chamber 11 for accommodating the gas with the pressure reaching the predetermined pressure, and the recovery chamber 12 for generating the predetermined vacuum degree. A specific type of the barrel 1 may be set according to actual requirement, which is not limited in the disclosure. For example, the barrel 1 may include a tube body and a chamber body. The tube body and the chamber body are coupled to each other, and the impact chamber 13 is formed in the tube body and the impact projectile 2 is arranged, the firing chamber 11 is formed in the chamber body, and the recovery chamber 12 is formed at an end of the tube body close to the chamber body. The barrel 1 may be set on a base platform through a plurality of hoop supports.

The impact projectile 2 is configured to move in the direction away from the recovery chamber 12 driven by the gas with the pressure reaching the predetermined pressure, achieving an out-of-chamber impact, and to move in the direction close to the recovery chamber 12 driven under the predetermined vacuum degree, achieving recovery and reset. A specific type of the impact projectile 2 may be set according to actual requirements, which is not limited in the disclosure. For example, the impact projectile 2 may be a structure that is adapted to the impact chamber 13 and is close to a columnar shape.

The firing apparatus 3 is configured to charge the firing chamber 11 with the gas to the predetermined pressure, to drive the impact projectile 2 to move in the direction away from the recovery chamber 12 utilizing the gas with the pressure reaching the predetermined pressure. A specific type of the firing apparatus 3 may be set according to actual requirements, which is not limited in the disclosure.

The recovery apparatus 4 is configured to evacuate the recovery chamber 12 to the predetermined vacuum degree, to drive the impact projectile 2 to move in the direction close to the recovery chamber 12 utilizing the vacuum. A specific type of the recovery apparatus 4 may be set according to actual requirements, which is not limited in the disclosure.

As illustrated in FIG. 1, FIG. 2 and FIG. 3, in some embodiments, the system further includes a first valve 5 and a second valve 6. The first valve 5 is provided between an air outlet end of the firing chamber 11 and an air inlet end of the recovery chamber 12, an air inlet end of the first valve 5 is coupled to the air outlet end of the firing chamber 11, and an air outlet end of the first valve 5 is coupled to the air inlet end of the recovery chamber 12. The second valve 6 is provided between the air outlet end of the recovery chamber 12 and the air inlet end of the recovery apparatus 4, and the air inlet end of the second valve 6 is coupled to the air outlet end of the recovery chamber 12, and the air outlet end of the second valve 6 is coupled to the air inlet end of the recovery apparatus 4. In a case where the air inlet end of the first valve 5 is connected to the air outlet end of the first valve 5, and the air inlet end of the second valve 6 is disconnected from the air outlet end of the second valve 6, the impact projectile 2 moves in the direction away from the recovery chamber 12 driven by the gas with the pressure reaching the predetermined pressure. In a case where the air inlet end of the first valve 5 is disconnected from the air outlet end of the first valve 5, and the air inlet end of the second valve 6 is connected to the air outlet end of the second valve 6, the recovery apparatus 4 evacuates the recovery chamber 12 to the predetermined vacuum degree to enable the impact projectile 2 to move in the direction close to the recovery chamber 12.

It can be understood that since the air inlet end of the first valve 5 is coupled to the air outlet end of the firing chamber 11, and the air outlet end of the first valve 5 is coupled to the air inlet end of the recovery chamber 12, the first valve 5 can control on or off of a path between the air outlet end of the firing chamber 11 and the air inlet end of the recovery chamber 12. Since the air inlet end of the second valve 6 is coupled to the air outlet end of the recovery chamber 12, and the air outlet end of the second valve 6 is coupled to the air inlet end of the recovery apparatus 4, the second valve 6 can control on or off of a path between the air outlet end of the recovery chamber 12 and the air inlet end of the recovery apparatus 4.

Therefore, in a case where the air inlet end of the first valve 5 is connected to the air outlet end of the first valve 5 and the air inlet end of the second valve 6 is disconnected from the air outlet end of the second valve 6, the gas with the pressure reaching the predetermined pressure in the firing chamber 11 can enter the recovery chamber 12 and drive the impact projectile 2 to move quickly in the direction away from the recovery chamber 12, achieving a powerful impact. In a case where the air inlet end of the first valve 5 is disconnected from the air outlet end of the first valve 5 and the air inlet end of the second valve 6 is connected to the air outlet end of the second valve 6, the recovery apparatus 4 can evacuate the recovery chamber 12 to the predetermined vacuum degree and drive the impact projectile 2 to move in the direction close to the recovery chamber 12, achieving recovery and reset.

It should be noted that the first valve 5 is configured to control on or off of the path between the air outlet end of the firing chamber 11 and the air inlet end of the recovery chamber 12. A specific type of the first valve 5 may be set according to actual requirements, which is not limited in the disclosure. For example, the first valve 5 may be an electromagnetic switch valve. In a case where the first valve 5 is turned on, the gas with the pressure reaching the predetermined pressure in the firing chamber 11 is instantly charged into the recovery chamber 12 and reaches the impact chamber 13, to achieve powerful out-of-chamber of the impact projectile 2.

The second valve 6 is configured to control on or off of the path between the air outlet end of the recovery chamber 12 and the air inlet end of the recovery apparatus 4. A specific type of the second valve 6 may be set according to actual requirements, which is not limited in the disclosure. For example, the second valve 6 may be an electromagnetic switch valve.

As illustrated in FIG. 1, FIG. 2 and FIG. 3, in some embodiments, the firing apparatus 3 includes a high-pressure air source 31, a third valve 32 and a first air pressure gauge 33. The third valve 32 is provided between an air outlet end of the high-pressure air source 31 and the air inlet end of the firing chamber 11, an air inlet end of the third valve 32 is coupled to the air outlet end of the high-pressure air source 31, and an air outlet end of the third valve 32 is coupled to the air inlet end of the firing chamber 11. A detection end of the first air pressure gauge 33 is provided in the firing chamber 11, the first air pressure gauge 33 is configured to detect a gas pressure in the firing chamber 11. In a case where the air inlet end of the first valve 5 is disconnected from the air outlet end of the first valve 5 and the air inlet end of the third valve 32 is connected to the air outlet end of the third valve 32, the high-pressure air source 31 charges the firing chamber 11 with gas until the gas pressure in the firing chamber 11 reaches the predetermined pressure.

It can be understood that since the air inlet end of the third valve 32 is coupled to the air outlet end of the high-pressure air source 31, and the air outlet end of the third valve 32 is coupled to the air inlet end of the firing chamber 11, the third valve 32 can control on or off of a path between the air outlet end of the high-pressure air source 31 and the air inlet end of the firing chamber 11. Since the detection end of the first air pressure gauge 33 is provided in the firing chamber 11, the first air pressure gauge 33 can detect the gas pressure in the firing chamber 11.

Therefore, in a case where the air inlet end of the first valve 5 is disconnected from the air outlet end of the first valve 5 and the air inlet end of the third valve 32 is connected to the air outlet end of the third valve 32, high-pressure gas from the high-pressure air source 31 can be charged into the firing chamber 11 through the third valve 32 until the gas pressure in the firing chamber 11 detected by the first air pressure gauge 33 reaches the predetermined pressure, thereby realizing driving of the impact projectile 2 in a case where the first valve 5 is turned on.

It should be noted that the high-pressure air source 31 is configured to store the high-pressure gas. A specific type of the high-pressure air source 31 may be set according to actual requirements, which is not limited in the disclosure.

The third valve 32 is configured to control on or off of the path between the air outlet end of the high-pressure air source 31 and the air inlet end of the firing chamber 11. A specific type of the third valve 32 may be set according to actual requirements, which is not limited in the disclosure. For example, the third valve 32 may be an electromagnetic switch valve.

The first air pressure gauge 33 is configured to detect the gas pressure in the firing chamber 11. A specific type of the first air pressure gauge 33 may be set according to actual requirements, which is not limited in the disclosure.

As illustrated in FIG. 1, FIG. 2 and FIG. 3, in some embodiments, the firing apparatus 3 further includes: a pressure regulating valve 34, the pressure regulating valve 34 is provided between the air inlet end of the third valve 32 and the air outlet end of the high-pressure air source 31, an air inlet end of the pressure regulating valve 34 is coupled to the air outlet end of the high-pressure air source 31, and an air outlet end of the pressure regulating valve 34 is coupled to the air inlet end of the third valve 32, the pressure regulating valve 34 is configured to adjust a gas pressure at the air outlet end of the high-pressure air source 31 to a firing pressure. In a case where the air inlet end of the first valve 5 is disconnected from the air outlet end of the first valve 5, the air inlet end of the third valve 32 is connected to the air outlet end of the third valve 32, and the air inlet end of the pressure regulating valve 34 is connected to the air outlet end of the pressure regulating valve 34, the high-pressure air source 31 charges the firing chamber 11 with gas until the gas pressure in the firing chamber 34 reaches the predetermined pressure.

It can be understood that since the air inlet end of the pressure regulating valve 34 is connected to the air outlet end of the high-pressure air source 31, and the air outlet end of the pressure regulating valve 34 is connected to the air inlet end of the third valve 32, the pressure regulating valve 34 can control the on or off of the path between the air inlet end of the third valve 32 and the air outlet end of the high-pressure air source 31, and adjust the gas pressure at the air outlet end of the high-pressure air source 31.

Therefore, in a case where the air inlet end of the first valve 5 is disconnected from the air outlet end of the first valve 5, the air inlet end of the third valve 32 is connected to the air outlet end of the third valve 32, and the air inlet end of the pressure regulating valve 34 is connected to the air outlet end of the pressure regulating valve 34, the high-pressure gas of the high-pressure air source 31 can be charged into the firing chamber 11 through the pressure regulating valve 34 and the third valve 32 sequentially, until the gas pressure in the firing chamber 11 detected by the first air pressure gauge 33 reaches the predetermined pressure. Therefore, the driving of the impact projectile 2 may be realized in a case where the first valve 5 is turned on, and the pressure regulating valve 34 can be used to adjust the gas pressure at the air outlet end of the high-pressure air source 31 to the firing pressure, thereby ensuring the stable and efficient compression of the gas in the firing chamber 11, and then ensuring the stable driving of the pressure gas on the impact projectile 2.

It should be noted that the pressure regulating valve 34 is configured to adjust the gas pressure at the air outlet end of the high-pressure air source 31 to the firing pressure. A specific type of the pressure regulating valve 34 may be set according to actual requirements, which is not limited in the disclosure.

As illustrated in FIG. 1, FIG. 2 and FIG. 3, in some embodiments, the recovery apparatus 4 includes: a vacuum pump 41 and a second air pressure gauge 42. An air inlet end of the vacuum pump 41 is coupled to the air outlet end of the second valve 6. A detection end of the second air pressure gauge 42 is provided in the recovery chamber 12, the second air pressure gauge 42 is configured to detect a vacuum degree in the recovery chamber 12. In a case where the air inlet end of the first valve 5 is disconnected from the air outlet end of the first valve 5 and the air inlet and the air inlet end of the second valve 6 is connected to the air outlet end of the second valve 6, the vacuum pump 41 extracts gas from the recovery chamber 12 until a vacuum degree in the recovery chamber 12 reaches a predetermined vacuum degree.

It can be understood that since the air inlet end of the vacuum pump 41 is connected to the air outlet end of the second valve 6, the vacuum pump 41 extracts the gas in a direction from the air inlet end of the second valve 6 to the air outlet end of the second valve 6. Since the detection end of the second air pressure gauge 42 is provided in the recovery chamber 12, the second air pressure gauge 42 can detect the vacuum degree in the recovery chamber 12.

Therefore, in a case where the air inlet end of the first valve 5 is disconnected from the air outlet end of the first valve 5 and the air inlet end of the second valve 6 is connected to the air outlet end of the second valve 6, the vacuum pump 41 can extract the gas from the recovery chamber 12 through the second valve 6 until the vacuum degree in the recovery chamber 12 reaches the predetermined vacuum degree. Therefore, stable and efficient recovery of the impact projectile 2 may be achieved.

It should be noted that the vacuum pump 41 is configured to extract the gas in a direction from the air inlet end of the second valve 6 to the air outlet end of the second valve 6 to achieve the predetermined vacuum degree in the recovery chamber 12. A specific type of the vacuum pump 41 may be set according to actual requirements, which is not limited in the disclosure.

The second air pressure gauge 42 is configured to detect the vacuum degree in the recovery chamber 12. A specific type of the second air pressure gauge 42 may be set according to actual requirements, which is not limited in the disclosure.

As illustrated in FIG. 1, FIG. 2 and FIG. 3, in some embodiments, the system further includes: a first limiter 7. The first limiter 7 is provided at an end of the impact chamber 13 close to the recovery chamber 12. In a case where the impact projectile 2 moves in a direction close to the recovery chamber 12, the first limiter 7 is configured to limit the impact projectile 2.

It can be understood that, since the first limiter 7 is provided at an end of the impact chamber 13 close to the recovery chamber 12, the first limiter 7 can limit the impact projectile 2, thereby ensuring stable recovery and reset of the impact projectile 2.

It should be noted that the first limiter 7 is configured to limit the impact projectile 2 in a case where the impact projectile 2 moves in a direction close to the recovery chamber 12. A specific type of the first limiter 7 may be set according to actual requirements, which is not limited in the disclosure. For example, the first limiter 7 may be an annular structure, and the first limiter 7 is arranged on an inner wall of the impact chamber 13 along a circumference of the barrel 1.

As illustrated in FIG. 1, FIG. 2 and FIG. 3, in some embodiments, the system further includes a uniformly loaded plate 8. The uniformly loaded plate 8 is slidably provided along the axial direction of the barrel 1 at an end of the impact chamber 13 away from the recovery chamber 12. The uniformly loaded plate 8 is configured to move in a direction away from the recovery chamber 12 driven by the impact projectile 2 in a case where the impact projectile 2 moves in the direction away from the recovery chamber 12, and to move in a direction close to the recovery chamber 12 driven by vacuum in the impact chamber 13 in a case where the impact projectile 2 moves in the direction close to the recovery chamber 12.

It can be understood that since the uniformly loaded plate 8 is slidably provided along the axial direction of the barrel 1 at an end of the impact chamber 13 away from the recovery chamber 12, the uniformly loaded plate 8 can move in the direction away from the recovery chamber 12 driven by the impact projectile 2 in a case where the impact projectile 2 moves in the direction away from the recovery chamber 12, thereby achieving uniform outward conduction of an impact force and ensuring high-quality impact of the seismic source system. In addition, in a case where the impact projectile 2 moves in the direction close to the recovery chamber 12, the vacuum is generated in the impact chamber 13 under a recovery action of the impact projectile 2, and acts on the uniformly loaded plate 8, causing the uniformly loaded plate 8 to move in the direction close to the recovery chamber 12 driven by the vacuum. Thus, reset is achieved to facilitate the next powerful impact.

It should be noted that the uniformly loaded plate 8 is configured to uniformly conduct the impact force on the impact projectile 2 outward. A specific type of the uniformly loaded plate 8 may be set according to actual requirements, which is not limited in the disclosure. For example, the uniformly loaded plate 8 is made of high-rigidity flame-retardant material.

As illustrated in FIG. 1, FIG. 2 and FIG. 3, in some embodiments, the system further includes: a plurality of slide bars 9 and a plurality of second limiters 10. Each of the plurality of slide bars 9 is provided along the axial direction of the barrel 1 at the end of the impact chamber 13 away from the recovery chamber 12, and the uniformly loaded plate 8 is slidably arranged on the slide bars 9. The plurality of second limiters 10 are respectively provided at ends of the plurality of slide bars 9 away from the impact chamber 13, and in a case where the uniformly loaded plate 8 moves in the direction away from the recovery chamber 12, the second limiter 10 is configured to limit the uniformly loaded plate 8.

It can be understood that since the plurality of slide bars 9 are respectively provided at an end of the impact chamber 13 away from the recovery chamber 12 along the axial direction of the barrel 1, and the uniformly loaded plate 8 is slidably arranged on the slide bars 9, the uniformly loaded plate 8 can achieve impact movement and reset movement using the plurality of slide bars 9, and since the plurality of second limiters 10 are respectively arranged at the ends of the plurality of slide bars 9 away from the impact chamber 13, the second limiters 10 can limit the uniformly loaded plate 8 to ensure stable impact of the uniformly loaded plate 8.

It should be noted that the second limiter 10 is configured to limit the uniformly loaded plate 8 in a case where the uniformly loaded plate 8 moves in the direction away from the recovery chamber 12. A specific type of the second limiter 10 may be set according to actual requirements, which is not limited in the disclosure. For example, the second limiter 10 may be an end plate structure, and a diameter of the second limiter 10 is larger than a diameter of the slide bar 9.

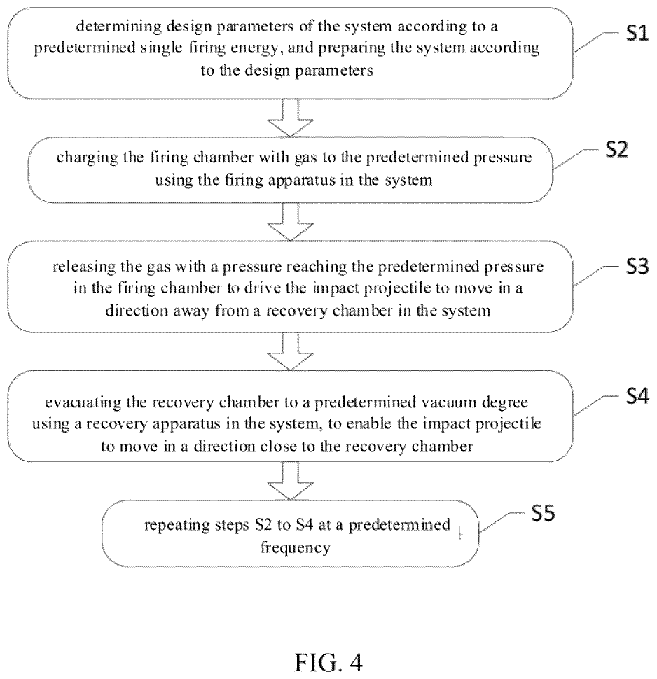

As illustrated in FIG. 4, an embodiment of the present disclosure further provides an impact method, which is based on the high-frequency, powerful, repeatable impact seismic source system as described in embodiments of the present disclosure. The method includes the following blocks.

At block S1, design parameters of the system are determined according to a predetermined single firing energy, and the system is prepared according to the design parameters. The design parameters include: a predetermined pressure of a gas driving an impact projectile in the system, a cross-sectional area of the impact projectile, a volume of a firing chamber in the system, and a length of the impact projectile.

At block S2, the firing chamber is charged with gas to the predetermined pressure using the firing apparatus in the system.

At block S3, the gas with a pressure reaching the predetermined pressure in the firing chamber is released to drive the impact projectile to move in a direction away from a recovery chamber in the system.

At block S4, the recovery chamber is evacuated to a predetermined vacuum degree using a recovery apparatus in the system, to enable the impact projectile to move in a direction close to the recovery chamber.

At block S5, steps S2 to S4 are repeated at a predetermined frequency.

It can be understood that the gas with the pressure reaching the predetermined pressure achieved by the firing apparatus enables high-speed and powerful launch of the impact projectile, and the predetermined vacuum degree achieved by the recovery apparatus enables rapid and smooth recovery of the impact projectile. Therefore, the system, as a seismic source, can perform high-frequency, powerful and repeatable impacts, thereby meeting requirements of shallow and deep seismic exploration.

It should be noted that user demands for detection depth and detection accuracy are ultimately reflected in the single firing energy E of the high-frequency, powerful, repeatable impact seismic source system. Therefore, E may be used as a core target parameter in designing the system.

In some embodiments, the method further includes:

determining the design parameters of the system based on a first constraint formula and a second constraint formula.

The first constraint formula is provided as: E=P²A(2V₀+kAL)/8ρL(V₀+kAL)Δt, where E is the single firing energy, P is the predetermined pressure of the gas driving the impact projectile, A is the cross-sectional area of the impact projectile, V₀ is the volume of the firing chamber, k is a volume coefficient, L is the length of the impact projectile, ρ is a density of the impact projectile, and Δt is a time when the impact projectile leaves a chamber.

The second constraint formula is provided as: L<0.9P₀/ρg, where P₀ is a standard atmospheric pressure at a location of the system, g is a gravitational acceleration at the location of the system.

It can be understood that the first constraint formula can be used to achieve precise control of a firing phase of the impact projectile in the system, and the second constraint formula can be used to achieve precise control of a recovery phase of the impact projectile in the system. Therefore, by combining the first constraint formula and the second constraint formula, it is ensured that the system, as a seismic source, can perform high-frequency, powerful and repeatable impacts.

It should be noted that the volume coefficient k may be set according to actual requirements, which is not limited in the disclosure. For example, the volume coefficient k may be in a range of 1.5-2.0.

For example, the following table may be obtained based on the first constraint formula and the second constraint formula. The following table represents a design quantitative relationship table of the predetermined pressure P, the cross-sectional area A of the impact projectile, and the length L of impact projectile of the firing apparatus in a case where an example of a firing energy, E=100 kJ, and an example of a material density of the impact projectile, ρ=7800 kg/m3, are given.

In which, “-” denotes that under a design parameter combination (P, R, L, E, ρ), the first constraint formula is satisfied, and the second constraint formula is not satisfied, that is, it can be fired but cannot be vacuum recovered.

| P = 1.0 MPa | | | P = 2.0 MPa | | | P = 3.0 MPa | | |
|---|---|---|---|---|---|---|---|---|
| R/m | A/m² | L/m | R/m | A/m² | L/m | R/m | A/m² | L/m |
| 0.050 | 0.008 | 0.368 | 0.050 | 0.008 | 0.931 | 0.050 | 0.008 | — |
| 0.060 | 0.011 | 0.363 | 0.060 | 0.011 | 0.854 | 0.060 | 0.011 | — |
| 0.070 | 0.015 | 0.357 | 0.070 | 0.015 | 0.770 | 0.070 | 0.015 | — |
| 0.080 | 0.020 | 0.352 | 0.080 | 0.020 | 0.682 | 0.080 | 0.020 | — |
| 0.090 | 0.025 | 0.346 | 0.090 | 0.025 | 0.594 | 0.090 | 0.025 | — |
| 0.100 | 0.031 | 0.341 | 0.100 | 0.031 | 0.511 | 0.100 | 0.031 | — |
| 0.110 | 0.038 | 0.337 | 0.110 | 0.038 | 0.437 | 0.110 | 0.038 | 0.871 |
| 0.120 | 0.045 | 0.333 | 0.120 | 0.045 | 0.378 | 0.120 | 0.045 | 0.574 |
| 0.130 | 0.053 | 0.331 | 0.130 | 0.053 | 0.341 | 0.130 | 0.053 | 0.383 |
| 0.140 | 0.062 | 0.330 | 0.140 | 0.062 | 0.331 | 0.140 | 0.062 | 0.333 |
| 0.150 | 0.071 | 0.332 | 0.150 | 0.071 | 0.355 | 0.150 | 0.071 | 0.458 |
| 0.160 | 0.080 | 0.336 | 0.160 | 0.080 | 0.422 | 0.160 | 0.080 | 0.797 |
| 0.170 | 0.091 | 0.343 | 0.170 | 0.091 | 0.540 | 0.170 | 0.091 | — |
| 0.180 | 0.102 | 0.354 | 0.180 | 0.102 | 0.716 | 0.180 | 0.102 | — |
| 0.190 | 0.113 | 0.369 | 0.190 | 0.113 | 0.961 | 0.190 | 0.113 | — |
| 0.200 | 0.126 | 0.390 | 0.200 | 0.126 | — | 0.200 | 0.126 | — |
| 0.210 | 0.139 | 0.415 | 0.210 | 0.139 | — | 0.210 | 0.139 | — |
| 0.220 | 0.152 | 0.447 | 0.220 | 0.152 | — | 0.220 | 0.152 | — |
| 0.230 | 0.166 | 0.486 | 0.230 | 0.166 | — | 0.230 | 0.166 | — |
| 0.240 | 0.181 | 0.532 | 0.240 | 0.181 | — | 0.240 | 0.181 | — |
| 0.250 | 0.196 | 0.587 | 0.250 | 0.196 | — | 0.250 | 0.196 | — |
| 0.260 | 0.212 | 0.651 | 0.260 | 0.212 | — | 0.260 | 0.212 | — |
| 0.270 | 0.229 | 0.725 | 0.270 | 0.229 | — | 0.270 | 0.229 | — |
| 0.280 | 0.246 | 0.809 | 0.280 | 0.246 | — | 0.280 | 0.246 | — |
| 0.290 | 0.264 | 0.906 | 0.290 | 0.264 | — | 0.290 | 0.264 | — |
| 0.300 | 0.283 | 1.015 | 0.300 | 0.283 | — | 0.300 | 0.283 | — |
| 0.310 | 0.302 | 1.138 | 0.310 | 0.302 | — | 0.310 | 0.302 | — |
| 0.320 | 0.322 | — | 0.320 | 0.322 | — | 0.320 | 0.322 | — |
| 0.330 | 0.342 | — | 0.330 | 0.342 | — | 0.330 | 0.342 | — |
| 0.340 | 0.363 | — | 0.340 | 0.363 | — | 0.340 | 0.363 | — |
| 0.350 | 0.385 | — | 0.350 | 0.385 | — | 0.350 | 0.385 | — |
| 0.360 | 0.407 | — | 0.360 | 0.407 | — | 0.360 | 0.407 | — |
| 0.370 | 0.430 | — | 0.370 | 0.430 | — | 0.370 | 0.430 | — |
| 0.380 | 0.454 | — | 0.380 | 0.454 | — | 0.380 | 0.454 | — |
| 0.390 | 0.478 | — | 0.390 | 0.478 | — | 0.390 | 0.478 | — |
| 0.400 | 0.503 | — | 0.400 | 0.503 | — | 0.400 | 0.503 | — |

Furthermore, significantly slower development of high-resolution seismic exploration technologies compared to conventional oil/gas seismic methods arises because the application field's focus on surrounding rock space operates at a significantly finer scale and higher precision (tunnel-scale: a range of 300 meters of surrounding rock, a precision of 0.3 meters to 0.5 meters), compared to a detection scale for surface oil and gas reservoirs (a range of 3 kilometers to 5 kilometers, a precision of 30 meters to 60 meters. This fundamental difference renders conventional “large-field, low-precision” geophysical seismic source equipment used in oil and gas reservoirs exploration fundamentally incompatible with detection and imaging requirements for “small-field high-precision” surrounding rock structures.

Therefore, in order to obtain a fine surrounding rock structure with a high resolution, an embodiment proposes a “small-field high-precision” structure detection system that delivers a wide frequency band firing (1 Hz-250 Hz real effective reflection signal frequency band within 300 m surrounding rock range), high energy, high penetration, and high controllability, engineered for an impact geophysical seismic source system for underground tunnel spaces. This embodiment is compared with the existing three types of mainstream seismic source technologies as follows.

(1) Compared with explosive seismic sources: the explosive seismic sources have core features of high energy, diffusion of seismic energy towards a target region being in a form of high-energy pulses, a wide frequency band, and have disadvantages including that drilling is required for firing, initiating explosive devices pose a danger during construction and can cause significant damage to a near surface when firing, and it cannot be applied in scenarios such as high-gas regions in coal mines and urban regions.

Due to provision of a high-energy broadband function, the system of this embodiment may achieve a detection depth equivalent to a detection depth of the explosive seismic source, and may also ensure that frequency bands of scattered signals and reflected signals are wide enough to ensure a precision of subsequent seismic imaging. Moreover, the system of this embodiment overcomes a technical difficulty of the explosive seismic source in that the explosive seismic source is a chemical explosion process, and its transient process is extremely difficult to control, which is manifested in that a seismic pulse wave fired is a complex waveform seismic wavelet with many sawtooths, many and complex side lobes, and difficulty in effectively controlling its repeatability, which makes it difficult to use its full waveform information during seismic imaging. The system of this embodiment uses a large-mass, regularly shaped impact projectile for impact firing, and can perform effectively controlled and repeatedly controllably firing on the waveform of the seismic wavelet by controlling a shape, a direction, a speed, a material, etc. of the impact projectile. Practice has shown that the seismic wavelet of the present disclosure has a large primary lobe and extremely small side lobes, and full waveform inversion imaging may be performed in subsequent high-resolution imaging.

(2) Comparison with controllable seismic source vehicles: the controllable seismic source vehicles are an important technical equipment in seismic exploration. Different from pulse waves fired by the explosive seismic sources, a feature of the controllable seismic source vehicle is that underground structure imaging is obtained by generating long-term swept-frequency seismic waves through artificial swept-frequency vibration using swept-frequency vibration technology and cross-correlation algorithm.

The controllable seismic source vehicle includes technical advantages of precisely controlling frequency and strength of a seismic source signal, and having a better signal-to-noise ratio. Compared with the conventional explosive seismic source, this method is safer and more environmentally friendly, reducing damage to the surrounding environment. In addition, the controllable seismic source vehicle has good mobility and can operate in different types of terrain conditions.

The controllable seismic source vehicle includes disadvantages that: since an actual sweep-frequency power is mainly concentrated in a low frequency band below 20 Hz, an actual effective frequency band of the controllable seismic source vehicle is low and cannot meet signal source requirements of high-resolution seismic imaging, an equipment cost is high, and operation and maintenance require professional technicians.

The system of this embodiment adopts a tracked vehicle form in a seismic source transportation form, inheriting advantages of the controllable seismic source vehicle in terms of convenience of mobile operation and little damage to the ground. Moreover, the system of this embodiment upgrades the sweep-frequency signal, which has a long period and a low energy density, requires cross-correlation processing to calculate an excitation form of virtual pulsed seismic waves, to direct firing of real wideband pulse waves using large-mass, high-speed pneumatic impact projectiles, greatly improving the real frequency band of the pulse waves. Since a resolution of the seismic imaging is directly proportional to the frequency band of the pulse wave, the system of this embodiment is more suitable for high-resolution seismic exploration imaging projects.

(3) Comparison with drop-hammer seismic sources: the drop-hammer seismic sources, also referred to as hammering seismic sources, are a common seismic source technology in seismic exploration. A technical feature of the drop-hammer seismic source includes generating seismic waves by hitting the ground with a free-falling heavy hammer. This method is simple and direct and is mainly used for shallow seismic exploration. The drop-hammer seismic source has advantages of low equipment cost, easy operation, no need for explosives, and reduced safety risks to the environment and personnel. In addition, because the equipment is light, it is suitable for use in places with inconvenient transportation or limited space.

The drop-hammer seismic source includes disadvantages that, since the hammer is excited by gravitational potential energy and spring energy, its energy is limited (usually 0.1 kJ-3.0 kJ), it is difficult to penetrate deeper underground structures and cannot effectively detect high signal-to-noise ratio reflection signals. However, the drop-hammer seismic source can form considerable surface wave energy. Therefore, the method of the drop-hammer seismic source has a limited exploration depth and a limited exploration accuracy, and is mainly used for shallow surface wave exploration, and is greatly affected by surface conditions, which may result in poor signal quality on hard or uneven surfaces.

In general, the drop-hammer seismic source is suitable for the shallow geological survey and provides an economical and effective solution for many exploration projects, but in deep exploration, it is necessary to combine other source technologies to obtain more comprehensive results. The system (1.0 kJ-15.0 kJ) of this embodiment is similar to the drop-hammer seismic source in terms of a firing form, in that a mass block hits a surface of a region to be measured to generate pulse waves. However, firing components of the system of this embodiment and the drop-hammer seismic source are completely different, thus, the seismic source in the system of this embodiment may achieve a deep body wave exploration function that is difficult to achieve with the drop-hammer seismic source.

In addition, the system of this embodiment may evaluate an energy conversion threshold K by pre-evaluating mechanical parameters of a target tunnel surface on-site. In a case where the energy of the impact projectile is less than K, surface wave energy is mainly generated, which is only suitable for surface wave exploration. In a case where the energy of the impact projectile is greater than K, a seismic energy component fired by the impact projectile may be reversed, which mainly includes deep body wave energy, while shallow surface waves may tend to be flat, in this case, the seismic source is suitable for deep high-resolution seismic exploration projects.

The core of the system of this embodiment is to set reasonable firing energy through on-site surface pre-evaluation under the effect of seismic energy component reversal, thereby realizing deep body wave exploration that cannot be achieved by the drop-hammer seismic source.

In the description of the present disclosure, terms such as “first” and “second” are used herein for purposes of description and are not intended to indicate or imply relative importance or significance. In addition, in the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may execute functions in a manner that is substantially simultaneous or in reverse order based on the functions involved, rather than in the order shown or discussed. This should be understood by those skilled in the art to which the embodiments of the present disclosure belong.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A high-frequency, powerful, repeatable impact seismic source system, comprising:
a barrel, provided with a firing chamber, a recovery chamber and an impact chamber connected sequentially;
an impact projectile, sealingly and slidably provided within the impact chamber along an axial direction of the barrel;
a firing apparatus, an air outlet end of the firing apparatus being coupled to an air inlet end of the firing chamber, the firing apparatus being configured to charge the firing chamber with gas to a predetermined pressure, wherein the impact projectile is configured to move in a direction away from the recovery chamber driven by the gas with a pressure reaching the predetermined pressure; and
a recovery apparatus, an air inlet end of the recovery apparatus being coupled to the air outlet end of the recovery chamber, the recovery apparatus being configured to evacuate the recovery chamber to a predetermined vacuum degree to enable the impact projectile to move in a direction close to the recovery chamber.

2. The system according to claim 1, further comprising:
a first valve, provided between an air outlet end of the firing chamber and an air inlet end of the recovery chamber, an air inlet end of the first valve being coupled to the air outlet end of the firing chamber, and an air outlet end of the first valve being coupled to the air inlet end of the recovery chamber; and
a second valve, provided between the air outlet end of the recovery chamber and the air inlet end of the recovery apparatus, and the air inlet end of the second valve being coupled to the air outlet end of the recovery chamber, and the air outlet end of the second valve being coupled to the air inlet end of the recovery apparatus;
wherein, in a case where the air inlet end of the first valve is connected to the air outlet end of the first valve, and the air inlet end of the second valve is disconnected from the air outlet end of the second valve, the impact projectile moves in the direction away from the recovery chamber driven by the gas with a pressure reaching the predetermined pressure;
in a case where the air inlet end of the first valve is disconnected from the air outlet end of the first valve, and the air inlet end of the second valve is connected to the air outlet end of the second valve, the recovery apparatus evacuates the recovery chamber to the predetermined vacuum degree to enable the impact projectile to move in the direction close to the recovery chamber.

3. The system according to claim 2, wherein the firing apparatus comprises:
a high-pressure air source;
a third valve, provided between an air outlet end of the high-pressure air source and the air inlet end of the firing chamber, an air inlet end of the third valve being coupled to the air outlet end of the high-pressure air source, and an air outlet end of the third valve being coupled to the air inlet end of the firing chamber; and
a first air pressure gauge, a detection end of the first air pressure gauge being provided in the firing chamber, the first air pressure gauge being configured to detect a gas pressure in the firing chamber;
wherein in a case where the air inlet end of the first valve is disconnected from the air outlet end of the first valve and the air inlet end of the third valve is connected to the air outlet end of the third valve, the high-pressure air source charges the firing chamber with gas until the gas pressure in the firing chamber reaches the predetermined pressure.

4. The system according to claim 3, wherein the firing apparatus further comprises:
a pressure regulating valve, provided between the air inlet end of the third valve and the air outlet end of the high-pressure air source, an air inlet end of the pressure regulating valve being coupled to the air outlet end of the high-pressure air source, and an air outlet end of the pressure regulating valve being coupled to the air inlet end of the third valve, the pressure regulating valve being configured to adjust a gas pressure at the air outlet end of the high-pressure air source to a firing pressure;
wherein in a case where the air inlet end of the first valve is disconnected from the air outlet end of the first valve, the air inlet end of the third valve is connected to the air outlet end of the third valve, and the air inlet end of the pressure regulating valve is connected to the air outlet end of the pressure regulating valve, the high-pressure air source charges the firing chamber with gas until the gas pressure in the firing chamber reaches the predetermined pressure.

5. The system according to claim 2, wherein the recovery apparatus comprises:
a vacuum pump, an air inlet end of the vacuum pump being coupled to the air outlet end of the second valve; and
a second air pressure gauge, a detection end of the second air pressure gauge being provided in the recovery chamber, the second air pressure gauge being configured to detect a vacuum degree in the recovery chamber;
wherein in a case where the air inlet end of the first valve is disconnected from the air outlet end of the first valve and the air inlet and the air inlet end of the second valve is connected to the air outlet end of the second valve, the vacuum pump extracts gas from the recovery chamber until a vacuum degree in the recovery chamber reaches a predetermined vacuum degree.

6. The system according to claim 1, further comprising:
a first limiter, provided at an end of the impact chamber close to the recovery chamber, wherein in a case where the impact projectile moves in a direction close to the recovery chamber, the first limiter is configured to limit the impact projectile.

7. The system according to claim 1, further comprising:
a uniformly loaded plate, the uniformly loaded plate being slidably provided along the axial direction of the barrel at an end of the impact chamber away from the recovery chamber;
wherein the uniformly loaded plate is configured to move in a direction away from the recovery chamber driven by the impact projectile in a case where the impact projectile moves in the direction away from the recovery chamber, and to move in a direction close to the recovery chamber driven by vacuum in the impact chamber in a case where the impact projectile moves in the direction close to the recovery chamber.

8. The system according to claim 7, further comprising:
a plurality of slide bars, each of which being provided along the axial direction of the barrel at the end of the impact chamber away from the recovery chamber, wherein the uniformly loaded plate is slidably arranged on the slide bars; and
a plurality of second limiters, respectively provided at ends of the plurality of slide bars away from the impact chamber, wherein in a case where the uniformly loaded plate moves in the direction away from the recovery chamber, the second limiter is configured to limit the uniformly loaded plate.

9. An impact method, for the high-frequency, powerful, repeatable impact seismic source system according to claim 1, comprising:
S1, determining design parameters of the system according to a predetermined single firing energy, and preparing the system according to the design parameters, wherein the design parameters comprise: a predetermined pressure of a gas driving an impact projectile in the system, a cross-sectional area of the impact projectile, a volume of a firing chamber in the system, and a length of the impact projectile;
S2, charging the firing chamber with gas to the predetermined pressure using the firing apparatus in the system;
S3, releasing the gas with a pressure reaching the predetermined pressure in the firing chamber to drive the impact projectile to move in a direction away from a recovery chamber in the system;
S4, evacuating the recovery chamber to a predetermined vacuum degree using a recovery apparatus in the system, to enable the impact projectile to move in a direction close to the recovery chamber;
S5, repeating steps S2 to S4 at a predetermined frequency.

10. The method according to claim 9, further comprising:
determining the design parameters of the system based on a first constraint formula and a second constraint formula;
wherein the first constraint formula is provided as:
$$E = {P}^{2} A ( 2 {V}_{0} + k AL ) / 8 ρ L ( {V}_{0} + kAL ) Δ t ,$$
where E is the single firing energy, P is the predetermined pressure of the gas driving the impact projectile, A is the cross-sectional area of the impact projectile, V₀ is the volume of the firing chamber, k is a volume coefficient, L is the length of the impact projectile, μ is a density of the impact projectile, and At is a time when the impact projectile leaves a chamber;
the second constraint formula is provided as:
$$L < 0.9 {P}_{0} / ρ g ,$$
where P₀ is a standard atmospheric pressure at a location of the system, g is a gravitational acceleration at the location of the system.

11. The method according to claim 9, wherein the system further comprises a first valve and a second valve, the first valve being provided between an air outlet end of the firing chamber and an air inlet end of the recovery chamber, an air inlet end of the first valve being coupled to the air outlet end of the firing chamber, and an air outlet end of the first valve being coupled to the air inlet end of the recovery chamber, and the second valve being provided between the air outlet end of the recovery chamber and the air inlet end of the recovery apparatus, and the air inlet end of the second valve being coupled to the air outlet end of the recovery chamber, and the air outlet end of the second valve being coupled to the air inlet end of the recovery apparatus,
wherein the method further comprises:
in a case where the air inlet end of the first valve is connected to the air outlet end of the first valve, and the air inlet end of the second valve is disconnected from the air outlet end of the second valve, driving, by the gas with a pressure reaching the predetermined pressure, the impact projectile to move in the direction away from the recovery chamber; and
in a case where the air inlet end of the first valve is disconnected from the air outlet end of the first valve, and the air inlet end of the second valve is connected to the air outlet end of the second valve, evacuating the recovery chamber to the predetermined vacuum degree by the recovery apparatus, to enable the impact projectile to move in the direction close to the recovery chamber.

12. The method according to claim 11, wherein the firing apparatus comprises:
a high-pressure air source; a third valve, provided between an air outlet end of the high-pressure air source and the air inlet end of the firing chamber, an air inlet end of the third valve being coupled to the air outlet end of the high-pressure air source, and an air outlet end of the third valve being coupled to the air inlet end of the firing chamber; and a first air pressure gauge, a detection end of the first air pressure gauge being provided in the firing chamber;
wherein the method further comprises:
detecting, by the first air pressure gauge, a gas pressure in the firing chamber; and
in a case where the air inlet end of the first valve is disconnected from the air outlet end of the first valve and the air inlet end of the third valve is connected to the air outlet end of the third valve, charging, by the high-pressure air source, the firing chamber with gas until the gas pressure in the firing chamber reaches the predetermined pressure.

13. The method according to claim 12, wherein the firing apparatus further comprises a pressure regulating valve, provided between the air inlet end of the third valve and the air outlet end of the high-pressure air source, an air inlet end of the pressure regulating valve being coupled to the air outlet end of the high-pressure air source, and an air outlet end of the pressure regulating valve being coupled to the air inlet end of the third valve, the pressure regulating valve being configured to adjust a gas pressure at the air outlet end of the high-pressure air source to a firing pressure;
wherein the method further comprises:
in a case where the air inlet end of the first valve is disconnected from the air outlet end of the first valve, the air inlet end of the third valve is connected to the air outlet end of the third valve, and the air inlet end of the pressure regulating valve is connected to the air outlet end of the pressure regulating valve, charging, by the high-pressure air source, the firing chamber with gas until the gas pressure in the firing chamber reaches the predetermined pressure.

14. The method according to claim 11, wherein the recovery apparatus comprises a vacuum pump, an air inlet end of the vacuum pump being coupled to the air outlet end of the second valve; and a second air pressure gauge, a detection end of the second air pressure gauge being provided in the recovery chamber,
wherein the method further comprises:
detecting, by the second air pressure gauge, a vacuum degree in the recovery chamber; and
in a case where the air inlet end of the first valve is disconnected from the air outlet end of the first valve and the air inlet and the air inlet end of the second valve is connected to the air outlet end of the second valve, extracting gas from the recovery chamber by the vacuum pump until a vacuum degree in the recovery chamber reaches a predetermined vacuum degree.

15. The method according to claim 9, wherein the system further comprises a first limiter, provided at an end of the impact chamber close to the recovery chamber, wherein in a case where the impact projectile moves in a direction close to the recovery chamber, the first limiter is configured to limit the impact projectile.

16. The method according to claim 9, wherein the system further comprises a uniformly loaded plate, the uniformly loaded plate being slidably provided along the axial direction of the barrel at an end of the impact chamber away from the recovery chamber;
wherein the method further comprises:
driving the uniformly loaded plate to move in a direction away from the recovery chamber by the impact projectile in a case where the impact projectile moves in the direction away from the recovery chamber,
driving the uniformly loaded plate to move in a direction close to the recovery chamber by vacuum in the impact chamber in a case where the impact projectile moves in the direction close to the recovery chamber.

17. The method according to claim 16, wherein the system further comprises a plurality of slide bars, each of which being provided along the axial direction of the barrel at the end of the impact chamber away from the recovery chamber, wherein the uniformly loaded plate is slidably arranged on the slide bars; and a plurality of second limiters, respectively provided at ends of the plurality of slide bars away from the impact chamber, wherein in a case where the uniformly loaded plate moves in the direction away from the recovery chamber, the second limiter is configured to limit the uniformly loaded plate.
